(19) United States
(12) Patent Application Publication
(10) Pub. No.: US 2006/0044716 A1
(43) Pub. Date: Mar. 2, 2006

(54) ESD protection circuit with improved trigger-on voltage

(75) Inventors: Chen-Chi Kuo, Tantz Shiang (TW); Shao-Chang Huang, Hsinchu City (TW)

Correspondence Address: DUANE MORRIS LLP;IP DEPARTMENT (TSMC), 30 SOUTH 17TH STREET, PHILADELPHIA, PA, 19103-4196, US

(73) Assignee: Taiwan Semiconductor Manufacturing Co., Ltd.

(21) Appl. No.: 10/931,458

(22) Filed: Aug. 31, 2004

(51) Int. Cl. H02H 9/00

(52) U.S. Cl. 361/56

(57) ABSTRACT

An electrostatic discharge (ESD) protection circuit includes at least one MOS transistor coupled between a power supply and ground. A voltage differentiation module is coupled between a gate and a substrate of the MOS transistor, such that a voltage difference is created between the gate and the substrate. Accordingly, a surface current path of the transistor is created in addition to a substrate current path from the gate to the substrate for dissipating an ESD current thereacross, during an ESD event. This improves a trigger-on voltage of the ESD protection circuit.

### BACKGROUND

The present invention relates generally to integrated circuit designs, and more particularly to an electrostatic discharge (ESD) protection circuit, utilizing voltage differentiation modules to enable both surface current path and substrate current path at the same time to reduce/control a trigger-on voltage of the ESD protection circuit during an ESD event.

The gate oxide of a metal-oxide-semiconductor (MOS) transistor of an integrated circuit (IC) is most susceptible to damage. The gate oxide may be destroyed by being contacted with a voltage only a few volts higher than the supply voltage. It is understood that a regular supply voltage in an integrated circuit is 5.0, 3.3 volts or even lower. Electrostatic voltages from common environmental sources can easily reach thousands, or even tens of thousands of volts. Such voltages are destructive even though the charge and any resulting current are extremely small. For this reason, it is of critical importance to discharge any static electric charge, as it builds up, before it accumulates to a damaging voltage.

ESD protective circuit is typically added to ICs at the bond pads. The pads are the connections to the IC, to outside circuitry, for all electric power supplies, electric grounds, and electronic signals. Such added circuitry must allow the normal operation of the IC. That means that the protective circuitry is effectively isolated from the normally operating core circuitry because it blocks current flow through itself. In an operating IC, electric power is supplied to a VCC pad, electric ground is supplied to a VSS pad, electronic signals are supplied from outside to some pads, and electronic signals generated by the core circuitry of the IC are supplied to other pads for delivery to external circuits and devices. In an isolated, unconnected IC, all pads are considered to be electrically floating, or of indeterminate voltage. In most cases, this means the pads are at ground, or zero voltage.

ESD can arrive at any pad. This can happen, for example, when a person touches some of the pads on the IC. This is the same static electricity that may be painfully experienced by a person who walks across a carpet on a dry day and then touches a grounded metal object. In an isolated IC, ESD acts as a brief power supply for one or more pads, while the other pads remain floating, or grounded. Because the other pads are grounded, when ESD acts as a power supply at a randomly selected pad, the protection circuitry acts differently than it does when the IC is operating normally. When an ESD event occurs, the protection circuitry must quickly become conductive so that the electrostatic charge is conducted to VSS or ground and dissipated before any damaging voltage may build up.

ESD protection circuitry, therefore, has two states: normal operation mode and ESD mode. When an IC is in normal operation, the ESD protection circuitry appears invisible to the IC by blocking current through itself. In the ESD mode, the ESD protection circuitry serves its purpose of protecting the IC by conducting an electrostatic charge quickly to VSS, or ground, before a damaging voltage can build up.

A typical ESD protection circuit uses a MOS transistor to control the opening and closing of the current path that is used to ground the harmful electrostatic current. If the MOS transistor is off, the circuit is in normal operation mode and IC can function without interruptions from the ESD protection circuit. When the MOS transistor is on, the IC will be isolated and protected by the ESD protection circuit. The voltage level that turns on the MOS transistor is called trigger-on voltage. If the trigger-on voltage is too high, it will take a long time to turn on the MOS transistor during an ESD event. In other words, the ESD current would flow into the IC for a while, until the MOS transistor is turned on. This may cause damages to the IC. Thus, it is desirable to lower the trigger-on voltage of an ESD protection circuit.

A conventional ESD protection circuit design is to have a an NMOS transistor coupled between a power supply and ground, in which the gate of the NMOS transistor is connected to the substrate of the same. During an ESD event, the gate voltage and the substrate voltage are rapidly raised by the ESD charge. This would turn on the NMOS transistor, and cause dissipation of the ESD current to ground through a surface current path, which is the channel region of the NMOS transistor, and a substrate current path, which is the current leakage path from the substrate. The surface current and substrate current together help lower the trigger-on voltage of the ESD protection circuit.

While this conventional ESD protection circuit is theoretically possible, it may not function up to the expectation in real implementation. Since the gate and the substrate of the NMOS transistor are connected together, the gate-to-substrate voltage V_{gb} is likely to be 0 volt during an ESD event. This 0 volt V_{gb} would prevent the gate of the NMOS transistor from being properly turned on, and therefore would not help lower the trigger-on voltage of the ESD protection circuit. It is very likely that, in real implementation, the conventional ESD protection circuit may not achieve what it claims to achieve, i.e., lowering the trigger-on voltage.

It is desirable for an ESD protection circuit to allow quicker dissipation of electrostatic current by lowering the trigger-on voltage of the same.

### SUMMARY

This invention provides an electrostatic discharge (ESD) protection circuit with an improved trigger-on voltage. In one embodiment, the ESD protection circuit includes at least one MOS transistor coupled between a power supply and ground. A voltage differentiation module is coupled between a gate and a substrate of the MOS transistor, such that a voltage difference is created between the gate and the substrate, thereby creating, during an ESD event, a surface current path of the transistor in addition to a substrate current path from the gate to the substrate for dissipating an ESD current thereacross.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1 illustrates a conventional ESD protection circuit, in which a gate and a substrate of a NMOS transistor are connected together.

FIG. 2A illustrates an ESD protection circuit, in accordance with a first embodiment of the present invention.

FIG. 2B illustrates an ESD protection circuit, in accordance with a second embodiment of the present invention.

FIG. 2C illustrates an ESD protection circuit, in accordance with a third embodiment of the present invention.

FIG. 3 illustrates a chart presenting experimental results of the ESD protection circuit, in accordance with various embodiments of the present invention.

### DESCRIPTION

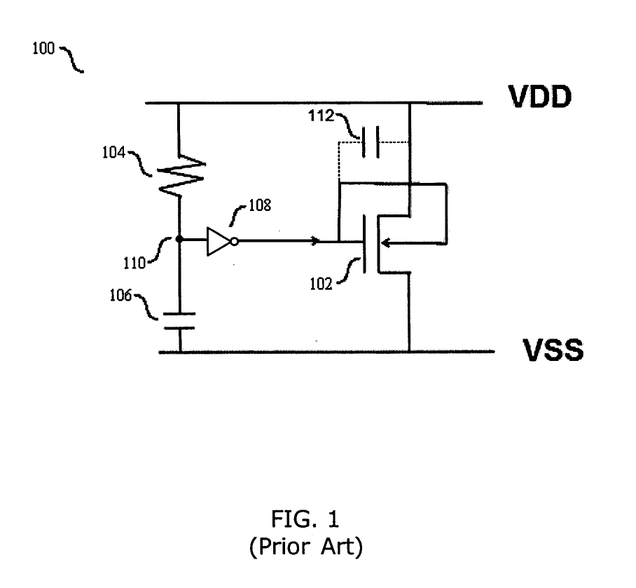

FIG. 1 presents a conventional ESD protection circuit 100 showing both the gate and the substrate of an NMOS transistor 102 connected together. The ESD protection circuit 100 has two modes of operation: normal operation mode and ESD mode. During the normal operation mode, the circuit 100 will appear invisible to an IC. In the ESD mode, the circuit 100 will serve its purpose in an ESD event by conducting electrostatic charge quickly down to VSS, or ground, to protect the IC before a damaging voltage can build up.

In the normal operation mode, the power supply VDD will supply the RC time constant network, composed of a resistor 104 and a capacitor 106, and a control inverter 108. With the supply voltage from VDD charging the RC network through the resistor 104, a node 110 will have a high signal. The inverter 108 inverts the high signal at node 110, and outputs a low signal to the gate of the NMOS transistor 102, thereby turning off the NMOS transistor 102. With the NMOS transistor 102 off, the drain-to-source current path of the NMOS transistor 102 will be closed, and the circuit 100 will have no effect on the IC.

The circuit 100 is susceptible to any ESD event when pins are not connected to power and ground. When an ESD event occurs, a positive ESD voltage that is significantly higher than VDD with respect to VSS is generated. At this point, the circuit 100 will enter the ESD mode. The NMOS transistor 102 is a large, gate-coupled ESD protection transistor that uses the upper PMOS of the inverter 108 to couple input signal from the VDD node to the gate of the NMOS transistor 102. The upper PMOS of the inverter 108 couples the positive input ESD signal to the gate of the NMOS transistor 102. This signal helps to turn on the NMOS transistor 102, thereby allowing it to absorb the ESD energy due to the low impedance drain-source path, i.e., the surface current path. This discharges the ESD current from VDD to ground, thereby protecting the IC before a damaging voltage can build up.

The gate and the substrate of the NMOS transistor 102 are connected to provide a current bleed path, i.e., the substrate current path, for further lowering the trigger-on voltage of the ESD protection circuit 100 in an ESD event. By connecting the gate and the substrate of the NMOS 102 together, some of the damaging charge that is built up during an ESD event may bleed through the substrate of the NMOS transistor 102.

By simply connecting the gate and the substrate of the NMOS transistor 102 together, however, the gate-to-substrate voltage V_{gb} of the NMOS transistor 102 becomes zero. The surface current path would not actually be created as so theoretically predicted in the above paragraph. This affects the ESD performance of the circuit 100. Since the NMOS transistor 102 cannot turn on easily when V_{gb} is equal to zero, and the drain-to-source current path of the NMOS 102 will not able to open at the early stage of an ESD event. As such, the conventional ESD protection circuit 100 may not achieve a lower trigger-on voltage as what it claims able to do.

This invention improves the conventional ESD protection circuit by implementing a voltage differentiation module that provides a voltage difference between the gate and the substrate of the MOS transistor. The voltage differentiation module, such as a resistor or diodes, are implemented between the gate and substrate of the NMOS transistor to provide an acceptable gate-to-substrate voltage difference V_{gb} that allows the protection circuit to function properly. By adding various numbers of diodes, the trigger-on voltage of the NMOS transistor also becomes adjustable. Lowering the trigger-on voltage by adding more diodes can enable faster dissipation of ESD current. This can better prevent any damage that could happen to the IC.

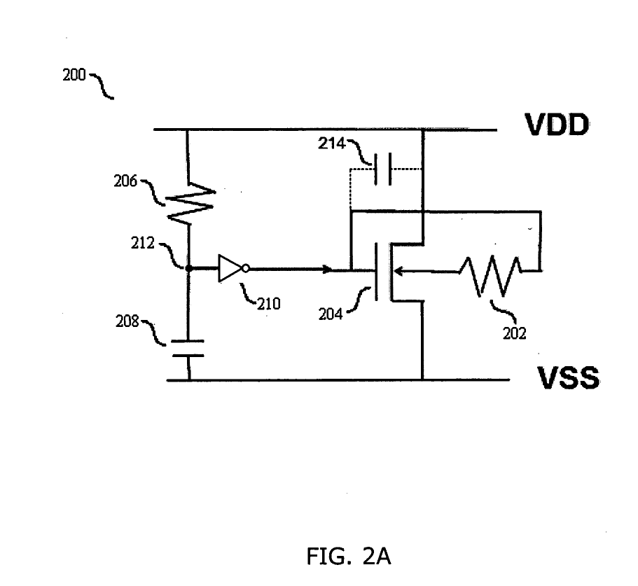

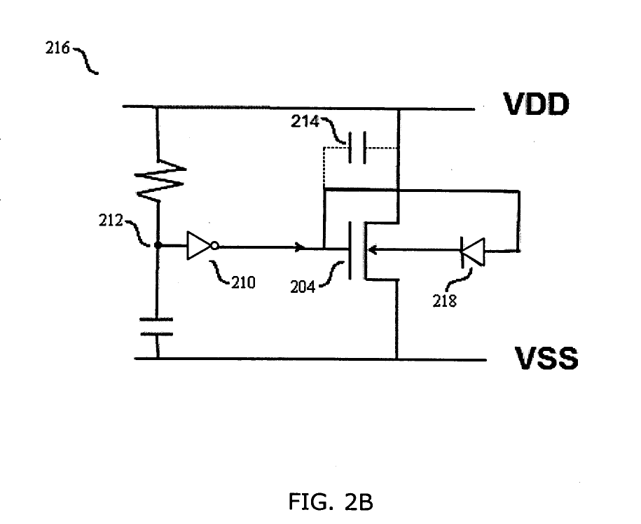

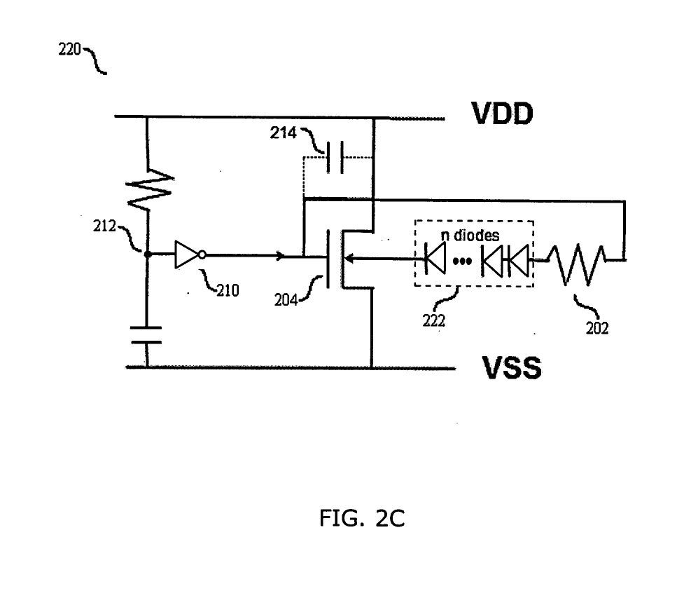

FIG. 2A illustrates an ESD protection circuit 200 with a resistor 202 implemented between the gate and the substrate of a NMOS transistor 204, in accordance with a first embodiment of the present invention. The NMOS transistor 204 is coupled between a power supply VDD and VSS, or ground. The gate of the NMOS transistor 204 is connected to the substrate of the same through the resistor 202. An ancillary resistor 206 and a capacitor 208 are coupled between the VDD and VSS. An inverter 210 has its input lead coupled to the power source through the ancillary resistor 206, and its output lead coupled to the gate of the NMOS transistor 204.

Like the circuit 100, the circuit 200 also has two modes of operation: normal operation mode and ESD mode. The resistor 202 allows gate-to-substrate voltage V_{gb} of the NMOS transistor 204 to be greater than 0 volt when an ESD event occurs, so that the transistor can turn on at an earlier stage to allow damaging current to flow to VSS.

During the normal operation mode, the circuit 200 is supplied by the voltage supply VDD. The RC time constant network, which comprises the ancillary resistor 206 and the capacitor 208, provides the inverter 210 with a signal by setting a node 212 high. The inverter 210 will invert the high signal from the node 212 to provide a low signal to the resistor 202 and the gate of the NMOS transistor 204. The low signal turns the NMOS transistor 204 off, thereby stopping current flow between VDD to VSS. As such, the circuit 200 has no practical effect on a core circuit during the normal operation.

When an ESD event occurs, the circuit 200 will be in the ESD mode. Once again, the NMOS transistor 204 is a large, gate-coupled ESD protection transistor using the upper PMOS of the inverter 210 to couple input signals from the VDD node to the gate of the NMOS transistor 204. The high signal helps turn on the NMOS transistor 204 during an ESD event, thereby allowing it to absorb the ESD energy due to the low impedance drain-source path, i.e., the surface current path. This opens up a path from VDD to VSS for discharging the ESD current to ground, thereby protecting the IC before any damaging voltage may build up.

This surface current path is supplemented with a substrate current path, which is ensured by providing a voltage difference between the gate and the substrate of the NMOS transistor 204. The resistor 202 would provide a minimum voltage difference of about 0.1 volt during an ESD event. The connection between the gate and the substrate of the NMOS transistor 204 allows some of the damaging charges that are built up during an ESD event to dissipate through the substrate of the NMOS transistor 204. This path is the substrate current path. The surface current path and the substrate current path, together, lower the trigger-on voltage of the ESD protection circuit 200. With the NMOS transistor 204 turned on, the drain-to-source current path of the NMOS 204 will be opened, thereby allowing the damaging electrostatic current at VDD to flow to VSS. In this embodiment, as an inherent design limitation, the voltage drop Vr across the resistor 202 should be smaller than a supply voltage VDD.

FIG. 2B illustrates an ESD protection circuit 216 with a diode 218 implemented between the gate and the substrate of the NMOS transistor 204 in accordance with a second embodiment of the present invention. The circuit 216 is identical to the circuit 200 in FIG. 2A, except that the resistor 202 in FIG. 2A is replaced with the diode 218 in FIG. 2B. The diode 218 serves the same purpose as the resistor 202 in the circuit 200 of FIG. 2A: they both allow the gate-to-substrate voltage of the NMOS transistor 204 to be higher than 0 volt, such that the NMOS transistor 204 may turn on, thereby creating a surface path allowing harmful electrostatic current to pass the drain and the source of the NMOS transistor 204 down to VSS during an ESD event. The resistor 202, the diode 218 and its combination may be refereed to as a voltage differential module, according to their functionality. The circuit 216, like the circuit 200 of FIG. 2A, also has two modes of operation: normal operation mode and ESD mode.

In normal operation mode, the ESD protection circuit 216 will be supplied by VDD. The node 212 will be high, thereby allowing the inverter 210 to present the gate of the NMOS transistor 204 and the anode side of the diode 218 with a low signal. Since the NMOS transistor 204 will be turned off, thereby shutting off the ESD current path, the ESD protection circuit 216 will have no effect on a core circuit during normal operation.

When an ESD event occurs, the circuit 216 will be in the ESD mode. Once again, the NMOS transistor 204 is a large, gate-coupled ESD protection transistor using the upper PMOS of the inverter 210 to couple input signals from the VDD node to the gate of the NMOS transistor 204. The high signal helps turn on the NMOS transistor 204 during an ESD event, thereby allowing it to absorb the ESD pulse energy due to the low impedance drain-source path, i.e., the surface current path. This opens up a path from VDD to VSS for discharging the electrostatic current to ground, thereby protecting the IC before any damaging voltage may build up.

The diode 218 between the gate and the substrate of the NMOS transistor 204 will ensure there is a voltage difference between the gate and the substrate of NMOS transistor 204, wherein the minimum voltage difference created is about 0.1 volt. This helps turn on the NMOS transistor 204, and dissipate the ESD current through the surface current path. The connection between the gate and the substrate of the NMOS transistor 204 allows a part of the ESD current to dissipate through the substrate current path. As such, the surface current path and the substrate current path, together, help to lower the trigger-on voltage of the ESD protection circuit 216. In this embodiment, the voltage drop Vd across the diode 218 should be smaller than a supply voltage VDD, as an inherent design limitation.

FIG. 2C illustrates an ESD protection circuit 220 with the resistor 202 serially connected to diodes 222, implemented between the gate and the substrate of the NMOS transistor 204, in accordance with a third embodiment of the present invention. Both the series of diodes 222 and the resistor 202 are implemented to allow the gate-to-substrate voltage V_{gb} to be much higher than 0 volt. However, with different number of diodes implemented, the trigger voltage of the NMOS 204 may be adjusted/controlled. As the number of diodes implemented between the gate and the substrate of the NMOS transistor 204 increases, the trigger-on voltage is reduced, thereby allowing the NMOS transistor 204 to turn on even faster, before any damaging amount of electrostatic current may build up sufficiently enough to harm either the NMOS transistor 204 or the IC.

During the normal operation of the IC, VDD will supply the circuit 220. Since this allows the node 212 to be at a high state, the inverter 210 will invert that high signal and feeds the gate of the NMOS transistor 204 and the resistor 202 with a low signal. Since the NMOS transistor 204 will turn off and the ESD current path will be closed, the circuit 220 will have no effect on the operation of the IC.

When an ESD event occurs, the circuit 220 will enter the ESD mode, and the NMOS transistor 204, which is a large, gate-coupled ESD protection transistor, uses the upper PMOS of the inverter 210 to couple input signals from the VDD node to the gate of the NMOS transistor 204. Once the gate voltage is higher than its trigger-on voltage, the NMOS transistor 204 turns on, thereby allowing it to absorb the ESD pulse energy due to the low impedance drain-source path. A path from VDD to VSS will be opened, thereby allowing the harmful ESD current to dissipate to ground before damaging charges builds up. The resistor 202 and diodes 222 work together to ensure the NMOS transistor 204 would turn on in an ESD event. In this embodiment, the voltage drop Vd across the diodes 222 plus the voltage drop Vr across the resistor 202 should be smaller than a supply voltage VDD, as an inherent design limitation. In addition, the minimum voltage difference created is about 0.1 volt.

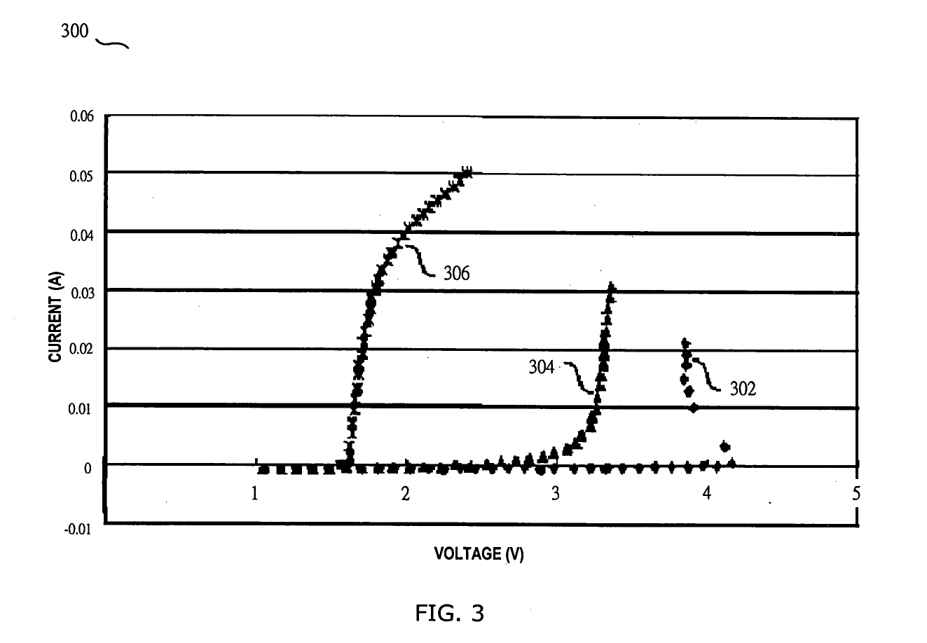

FIG. 3 presents a chart 300 showing various trigger-on voltages when diodes are implemented between the gate and substrate of the NMOS transistor 102 in the circuit 100 of FIG. 1. The chart 300 has results of three different tests: a test 302 with no diode implemented; a test 304 with one diode implemented; and a test 306 with two diodes implemented. The trigger-on voltage of the test 302 with no diode or resistor implemented was about 4.17 volts. This is almost the same as the trigger-on voltage without having the gate and the substrate connected. The trigger-on voltage of the test 304 with one diode implemented was about 2.54 volts, while the trigger-on voltage of the test 306 with two diodes implemented was about 1.57 volts. The chart 300 shows that, when one or more diodes are implemented between the gate and the substrate of the NMOS transistor 102, the trigger-on voltage of the ESD protection circuit 100 can be lowered. The lower triggering voltage can help turning on an ESD protection device in a shorter amount of time.

The above illustrations provide many different embodiments for implementing different features of this invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. An electrostatic discharge (ESD) protection circuit comprising:
at least one MOS transistor coupled between a power supply and ground; and
a voltage differentiation module coupled between a gate and a substrate of the MOS transistor such that a voltage difference is created between the gate and the substrate, thereby creating, during an ESD event, a surface current path of the transistor in addition to a substrate current path from the gate to the substrate for dissipating an ESD current thereacross.

2. The ESD protection circuit of claim 1 wherein the MOS transistor is a NMOS transistor.

3. The ESD protection circuit of claim 1 wherein the voltage differentiation module comprise at least one diode.

4. The ESD protection circuit of claim 1 wherein the voltage differentiation module comprises at least one resistor to create a minimum voltage difference of about 0.1 volt.

5. The ESD protection circuit of claim 1 further comprising an ancillary resistor and a inverter coupled between the power supply and the gate of the MOS transistor.

6. The ESD protection circuit of claim 5 further comprising a capacitor coupled between the ancillary resistor and ground.

7. The ESD protection circuit of claim 1 wherein the voltage differentiation module is a diode and resistor combination.

8. An electrostatic discharge (ESD) protection circuit comprising:
at least one NMOS transistor coupled between a power supply and ground, wherein a voltage differentiation module is placed between the gate and the substrate, thereby lowering a trigger-on voltage thereof during an ESD event.

9. The ESD protection circuit of claim 8 wherein the voltage differentiation module comprise at least one diode.

10. The ESD protection circuit of claim 8 wherein the voltage differentiation module comprises at least one resistor to create a minimum voltage difference of about 0.1 volt.

11. The ESD protection circuit of claim 8 further comprising an ancillary resistor and a inverter coupled serially between the power supply and the gate of the transistor.

12. The ESD protection circuit of claim 11 further comprising a capacitor coupled between the ancillary resistor and ground.

13. The ESD protection circuit of claim 8 wherein the voltage differentiation module is a diode and resistor combination.

14. An integrated circuit comprising:
an electrostatic discharge (ESD) protection circuit having at least one NMOS transistor coupled between a power supply and ground with a voltage differentiation module having at least one diode placed between the gate and the substrate thereof; and
a core circuit protected by the ESD protection circuit,
wherein the voltage differentiation module lowers a trigger-on voltage of the ESD protection circuit during an ESD event so that the ESD protection circuit is turned on in time to protect the core circuit.

15. The integrated circuit of claim 14 wherein the voltage differentiation module further comprise at least one resistor.

16. The integrated circuit of claim 14 further comprising an ancillary resistor and a inverter coupled serially between the power supply and the gate of the transistor.

17. The integrated circuit of claim 14 further comprising a capacitor coupled between the ancillary resistor and ground.
